(19) United States
(12) Patent Application Publication
(10) Pub. No.: US 2008/0286737 A1
(43) Pub. Date: Nov. 20, 2008

(54) Adaptive Engine Logic Used in Training Academic Proficiency

(75) Inventors: Lewis Cheng, San Jose, CA (US); Bella Kong, San Jose, CA (US); Jason Ng, San Jose, NY (US); Simon Lee, San Jose, CA (US); Joshua Levine, San Jose, CA (US)

Correspondence Address: Patrice A King;GOODWIN PROCTOR, 599 Lexington Avenue, New York, NY, 10022, US

(73) Assignee: PLANETII USA INC., San Jose, CA (US)

(21) Appl. No.: 10/551,663

(22) PCT Filed: Apr. 2, 2004
(86) PCT No.: PCT/US04/10222

§ 371 Date: Aug. 16, 2006

Related U.S. Application Data
(60) Provisional application No. 60/459,773, filed on Apr. 2, 2003.

(51) Int. Cl. G09B 7/00; G09B 19/00

(52) U.S. Cl. 434/322; 434/188

(57) ABSTRACT

The present invention is an intelligent, adaptive system that takes in information and reacts to the specific information given to it, using a set of predefined heuristics. Therefore, each individual's information (which can and is unique) will feed the engine, and then provide a unique experience to that individual. One embodiment of the present invention discussed herein focuses on Mathematics however the invention is not limited thereby as the same logic can be applied to other academic subjects.

### CLAIM OF PRIORITY/CROSS REFERENCE OF RELATED APPLICATION(S)

This application claims the benefit of priority of United States Provisional Application No. 60/459,773, filed Apr. 2, 2003, entitled “Adaptive Engine Logic Used in Training Academic Proficiency,” hereby incorporated in its entirety herein.

### COPYRIGHT/TRADEMARK STATEMENT

A portion of the disclosure of this patent document may contain material which is subject to copyright and/or trademark protection. The copyright/trademark owner has no objection to the facsimile reproduction by anyone of the patent document or the patent disclosure, as it appears in the Patent Office patent files or records, but otherwise reserves all copyrights and trademarks.

### STATEMENT REGARDING FEDERALLY SPONSORED RESEARCH OR DEVELOPMENT

Not applicable.

### BACKGROUND

1. Field of the Invention

The present invention relates generally to computerized learning and more particularly to an adaptive learning system and method that utilizes a set of heuristics to provide a learning environment unique to an individual.

2. Description of Related Art

### The Problem

A child's learning pace varies from child to child. Schools often provide education that is tailored to a general standard, to the “normal” child. Teachers and facilitators often gear materials, e.g. static curriculum, and pedagogical direction toward the majority of the classroom—the so-called normal child—and therefore neglect children with different needs on either end of the spectrum.

Because the collection of concepts mastered by different students varies, without a personalized curriculum tailored for the student, it is oftentimes difficult to help different students with different abilities to develop a solid foundation in a particular subject.

### Prior Art Solutions to the Problem

There are a number of education-based, and more specifically math-based, Internet web sites available today. Also, there are many offline products, such as workbooks, CD-ROMs, and games that also address this issue. In addition there is also traditional human help, such as a teacher and/or tutor.

### Commercial Examples in the Math Arena:

www.aleks.com—A fully automated online math tutor for K-12 and Higher Education students. Below is an excerpt from their corporate website.

ALEKS is a revolutionary Internet technology, developed at the University of California by a team of gifted software engineers and cognitive scientists, with the support of a multi-million dollar grant from the National Science Foundation. ALEKS is fundamentally different from previous educational software. At the heart of ALEKS is an artificial intelligence engine—an adaptive form of computerized intelligence—which contains a detailed structural model of the multiplicity of the feasible knowledge states in a particular subject. Taking advantage of state of the art software technology, ALEKS is capable of searching an enormous knowledge structure efficiently, and ascertaining the exact knowledge state of the individual student. Like “Deep Blue,” the IBM computer system that defeated international Chess Grand master Garry Kasparov, ALEKS interacts with its environment and adapts its output to complex and changing circumstances. ALEKS is based upon path breaking theoretical work in Cognitive Psychology and Applied Mathematics in a field of study called “Knowledge Space Theory.” Work in Knowledge Space Theory was begun in the early 1980's by an internationally renowned Professor of Cognitive Sciences who is the Chairman and founder of ALEKS Corporation.
Using state-of-the-art computerized intelligence and Web-based programming, ALEKS interacts with each individual student, and functions as an experienced one-on-one tutor.
Continuously adapting to the student, ALEKS develops and maintains a precise and comprehensive assessment of your kowledge state.
ALEKS always teaches what the individual is most ready to learn.
For a small fraction of the cost of a human tutor, ALEKS can be used at any time: 24 hours per day; 7 days per week, for an unlimited number of hours.

Kumon Math Program—a linear and offline paper-based math program that helps children develop mechanical math skills. 2.5 million students or more worldwide.

Math Blasters—A CD-ROM that provides some math training through fun games.

Ms. Lindquist: The Tutor—a web-based math tutor specialized in helping children solving algebraic problems using a set of artificial intelligence algorithms. It was developed by a researcher at Carnegie Mellon University

Cognitive Tutor—Developed by another researcher at Carnegie Mellon University. It helps students solve various word-based algebraic and geometric problems with real-time feedback as students perform their tasks. The software predicts human behavior, makes recommendations, and tracks student-user performance in real time. The software is sold by Carnegie Learning.

### Limitations of the Prior Art

Many internet/web sites do not offer a truly personalized experience. In their systems, each student-user answers the same 10 questions (for example), regardless of whether they answer the first questions correctly or incorrectly. These are examples of non-intelligence, or limited intelligence, backed by a linear, not relational, curriculum.

Other offline products (like CD-ROMs) have the ability to provide a somewhat personalized path, depending on questions answered correctly or incorrectly, but their number of questions is limited to the storage capacity of the CD-ROM. CD-ROMs and off-line products are also not flexible to real-time changes to content. CD-ROMs also must be installed on a computer. Some may only work with certain computer types (e.g., Mac or PC), and if the computer breaks, one must re-install it on another machine, and start all over with the product.

### The Present Solution to the Problem

The present invention solves the aforementioned limitations of the prior art. The present invention is intended to fill in the gaps of what schools cannot provide an individualized curriculum that is driven by the child's own learning pace and standards. The major goal is to use the invention to help each child build a solid foundation in the subject as early as possible, and then move on to more difficult material. The present invention is an intelligent, adaptive system that takes in information and reacts to the specific information given to it, using a set of predefined heuristics. Therefore, each individual's information (which can and is unique) will feed the engine, and then provide a unique experience to that individual. One embodiment of the present invention discussed herein focuses on Mathematics however the invention is not limited thereby as the same logic can be applied to other academic subjects.

In accordance with one aspect of the present invention, there is provided, based on a curriculum chart with correlation coefficients and prerequisite information, unlimited curriculum paths that respond to students' different learning patterns and pace. Topics are connected with each other based on pre-requisite/post-requisite relationship thus creating a complex 3-D curriculum web. Each relationship is also quantified by a correlation coefficient. Each topic contains a carefully designed set of questions in increasing difficulty levels (e.g., 1-100). Thus, without acquiring a certain percentage of pre-requisites, a student-user will be deemed not ready to go into a specific topic.

In a second aspect of the present invention, all of the programming for the heuristics and the logic is done in the Java programming language. In addition, the present invention has been adapted to accept information, via the Internet, using a browser as a client. Furthermore, information is stored in a database, to help optimize the processing of the information.

Certain features and advantages of the present invention include: a high level of personalization, continuous programs accessible anytime and anywhere, real-time performance tracking systems that allow users, e.g., parents to track progress information online, a relational curriculum, enabling individualized paths from question to question and from topic to topic, worldwide comparison mechanisms that allow parents to compare child performance against peers in other locations. The above aspects, features and advantages of the present invention will become better understood with regard to the following description.

### BRIEF DESCRIPTION OF THE DRAWING(S)

Referring briefly to the drawings, embodiments of the present invention will be described with reference to the accompanying drawings in which:

FIGS. 1-15 depict various aspects and features of the present invention in accordance with the teachings expressed herein.

### DETAILED DESCRIPTION OF THE PRESENT INVENTION

Although what follows is a description of a preferred embodiment of the invention, it should be apparent to those skilled in the art that the following is illustrative only and not limiting, having been presented by way of example only. All the features disclosed herein may be replaced by alternative features serving the same purpose, and equivalents of similar purpose, unless expressly stated otherwise. Therefore, numerous other embodiments of the modifications thereof are contemplated as falling within the scope of the present invention. However, all specific details may be replaced with generic ones. Furthermore, well-known features have not been described in detail so as not to obfuscate the principles expressed herein.

Moreover, the techniques may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, NVRAM, ROM, hard disk, magnetic diskette or carrier wave) that is readable by a general or special purpose programmable computer for configuring and operating the computer when the storage medium; or device is read by the computer to perform the procedures described in this document. The system may also be considered to be implemented as a computer-readable storage medium, configured with a computer program, where the storage medium so configured causes a computer to operate in a specific and predefined manner.

The engine and the algorithms and methodology that it was developed for, is currently specific for Mathematics at this time. But, using the same structure, it can be broadened and used in any numbers of scenarios. The function of the engine is primarily to react on information, or data, given to it. Then, based on a set of rules or governing heuristics, it will react to the data, and provide meaningful output. This ideology can be used in a number of different applications.

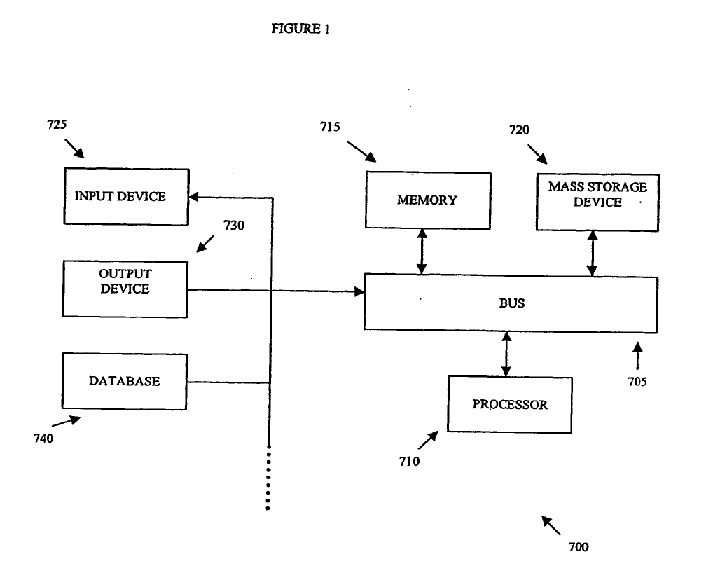

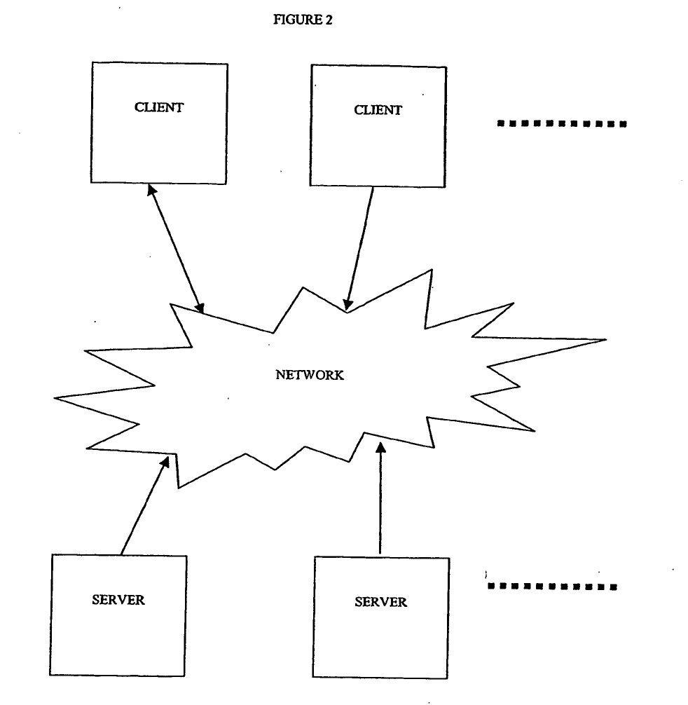

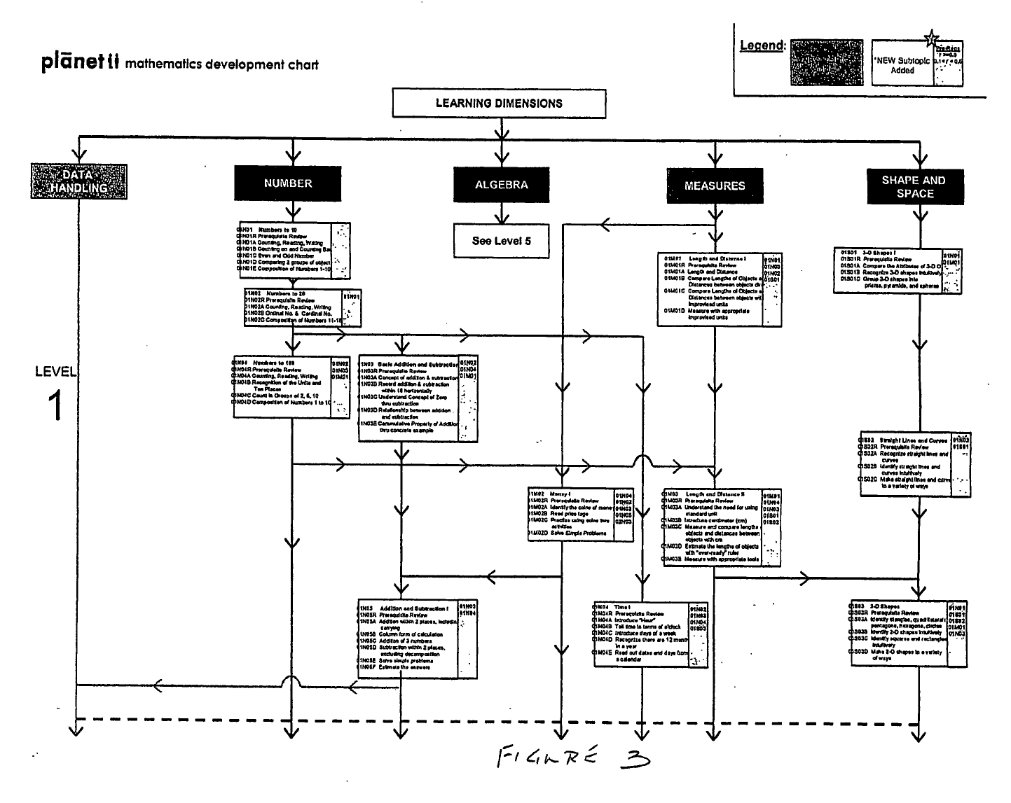

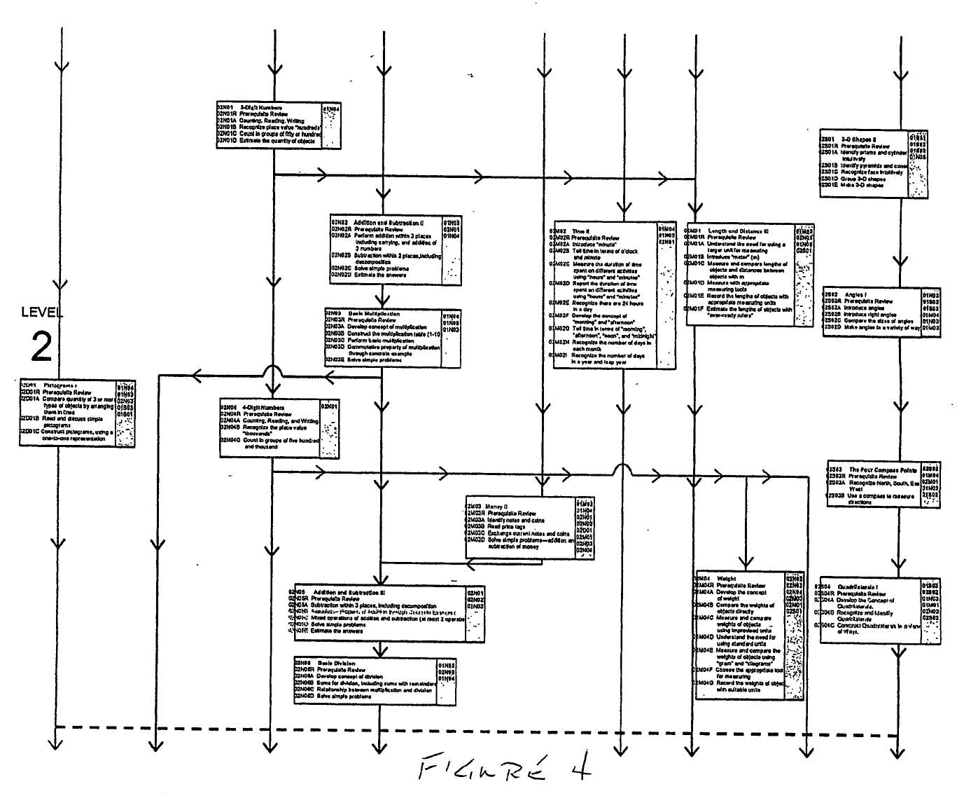

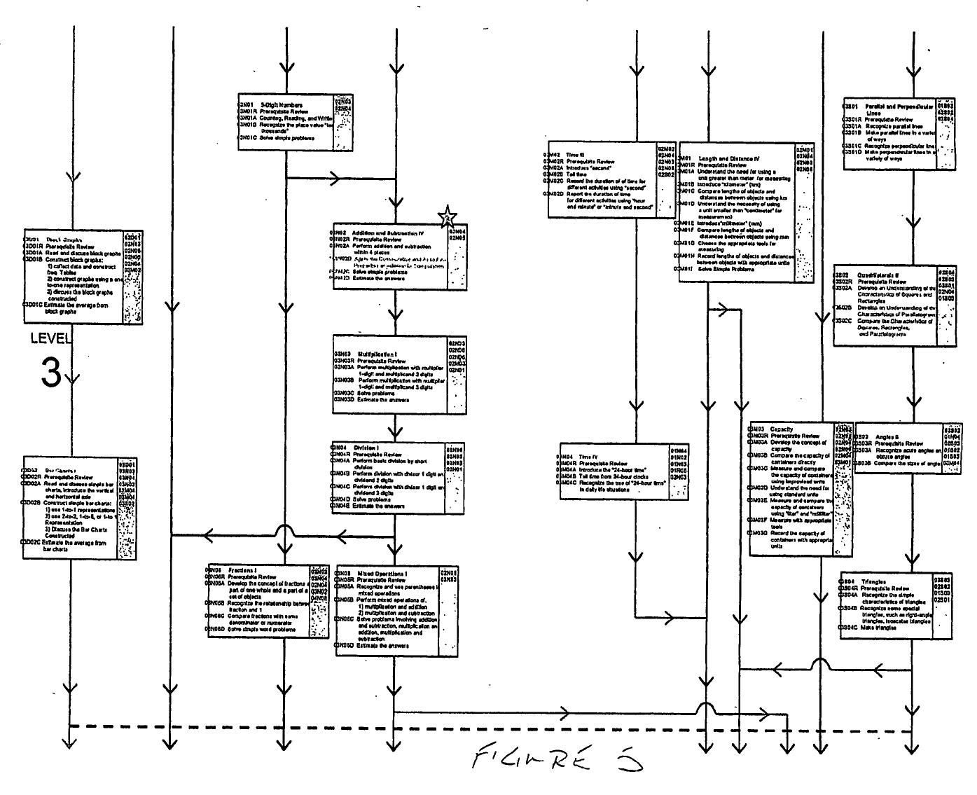

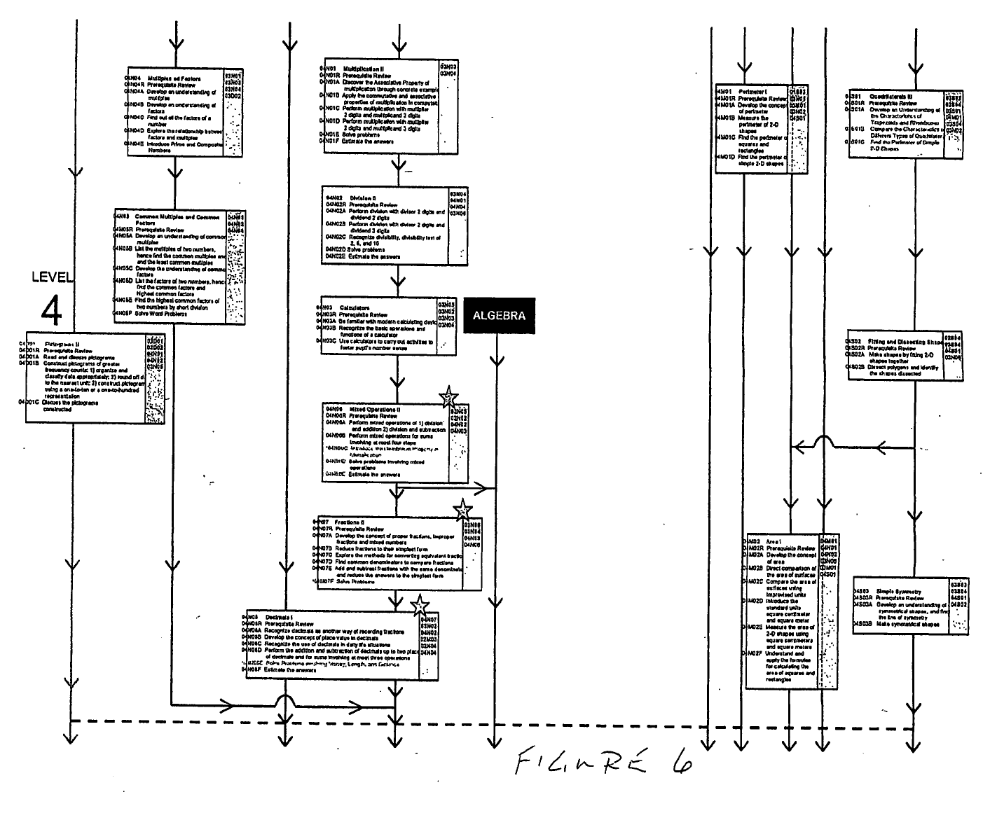

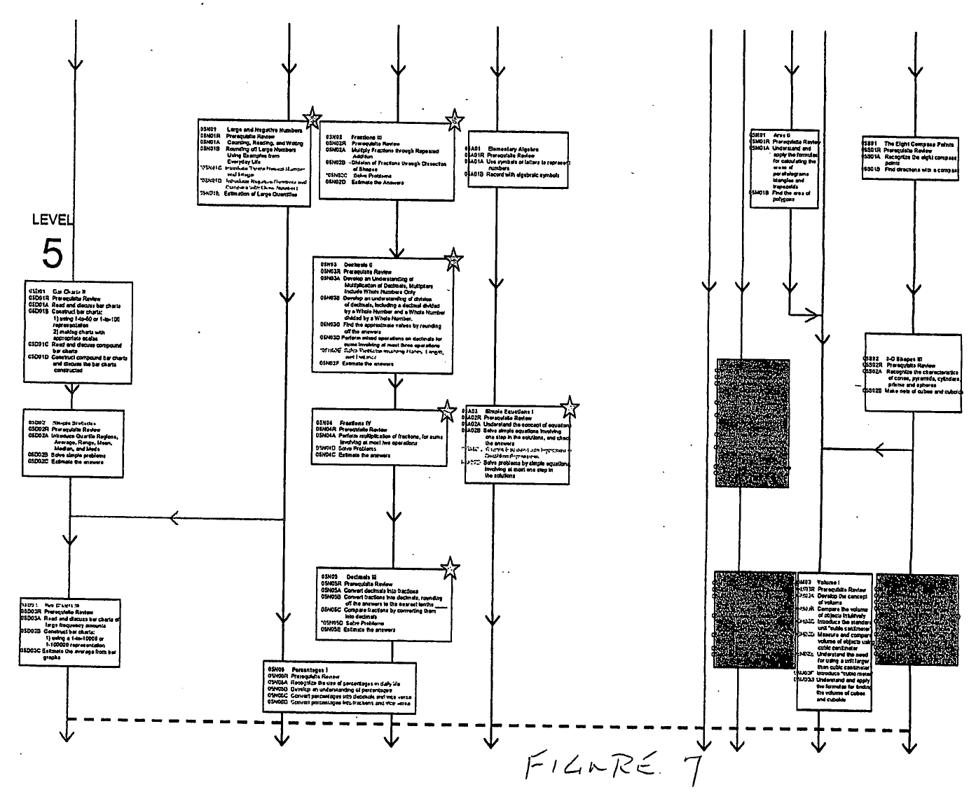

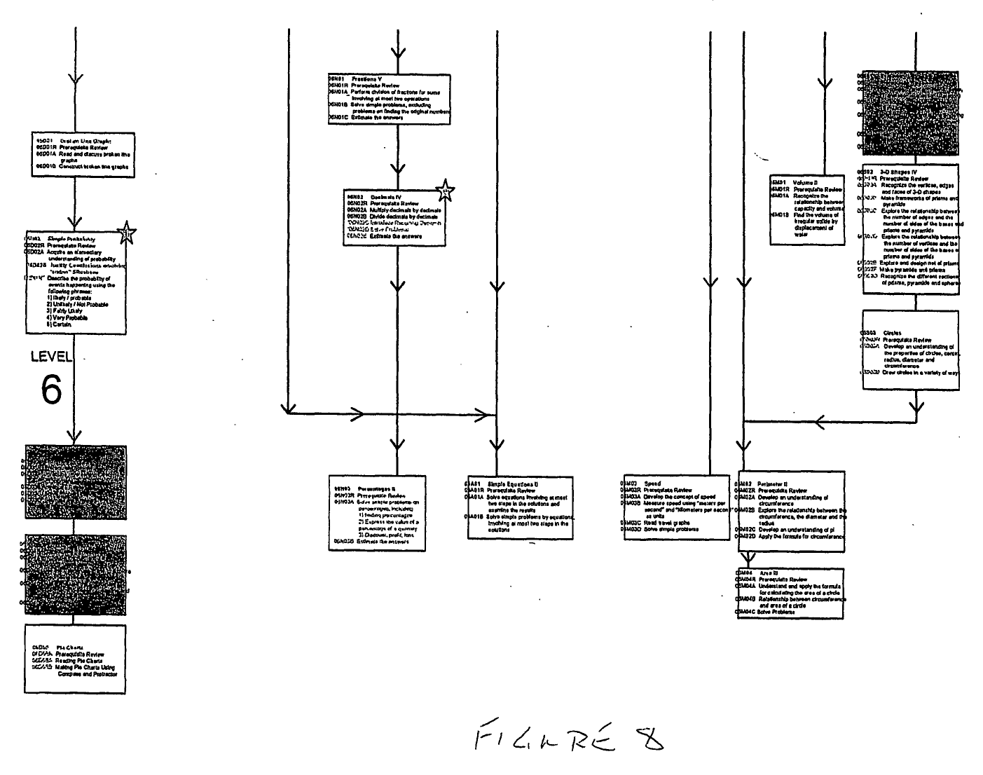

FIGS. 1 and 2 illustrate exemplary hardware configurations of a processor-controlled system on which the present invention is implemented. One skilled in the art will appreciate that the present invention is not limited by the depicted configuration as the present invention may be implemented on any past, present and future configuration, including for example, workstation/desktop/laptop/handheld configurations, client-server configurations, n-tier configurations, distributed configurations, networked configurations, etc., having the necessary components for carrying out the principles expressed herein. In its most basic embodiment however, FIG. 1 depicts a system 700 comprising, but not limited to, a bus 705 that allows for communication among at least one processor 710, at least one memory 715 and at least one storage device 720. The bus 705 is also coupled to receive inputs from at least one input device 725 and provide outputs to at least one output device 730. The at least one processor 710 is configured to perform the techniques provided herein, and more particularly, to execute the following exemplary computer program product embodiment of the present invention. Alternatively, the logical functions of the computer program product embodiment may be distributed among processors connected through networks or other communication means used to couple processors. The computer program product also executes under various operating systems, such as versions of Microsoft Windowsä, Apple Macintoshä, UNIX, etc. Additionally, in a preferred embodiment, the present invention makes use of conventional database technology 740 such as that found in the commercial product SQL Server® which is marketed by Microsoft Corporation, to store, among other things, the body of questions. FIGS. 3-8 illustrate one such order data organization comprising Learning Dimensions, Proficiency Levels, Topics, Questions, etc.

As shown in FIG. 2, in another embodiment, the present invention is implemented as a networked system having at least one client (e.g., desktop, workstation, laptop, handheld, etc) in communication with at least one server (e.g., application, web, and/or database servers, etc.,) via a network, such as the Internet.

The present invention utilizes a comprehensive curriculum map that outlines relational correlations between distinct base-level categories of mathematical topics, concepts and skill sets.

The present invention generates an individually tailored curriculum for each user, which is a result of the user's unique progression through the curriculum map, and is dynamically determined in response to the user's ongoing performance and proficiency measurements within each mathematical topic category. To illustrate the mechanisms behind this process, attention must first be paid to the mathematical topic category entity itself and its many features.

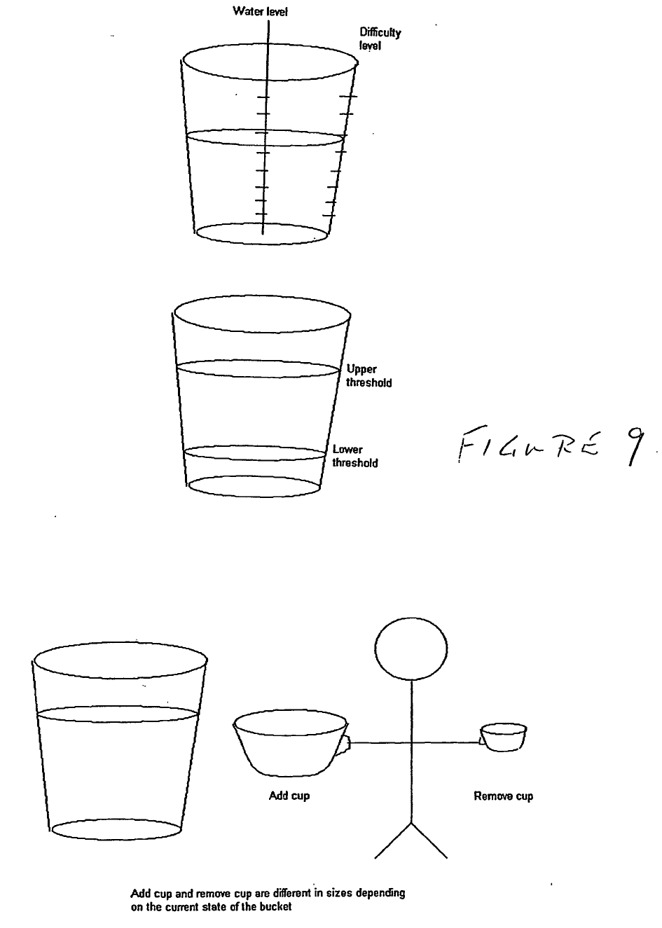

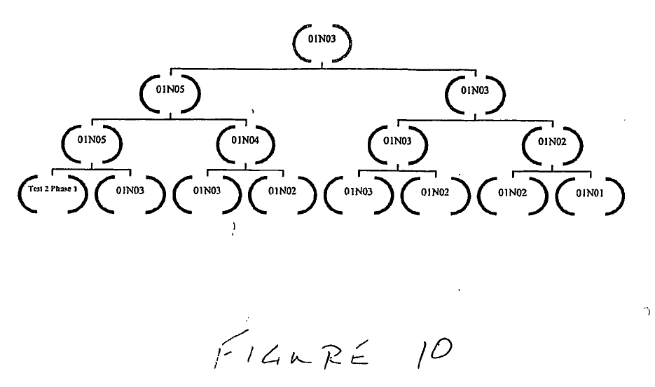

Each of the distinct mathematical topic category entities defined on the curriculum map is represented technically as an object, with a vast member collection of related exercise questions and solutions designed to develop skills and proficiency in the particular topic represented. Each category object also maintains a Student-user Proficiency Level measurement that continually indicates each user's demonstrated performance level in that particular category. In addition, each category object also maintains a Question Difficulty Level that determines the difficulty of any questions that may be chosen from the object's question collection and presented to the user. As expected, the movement of an object's Question Difficulty Level is directly correlated to the movement of the Student-user Proficiency Level. Referring to FIG. 9, conceptually, each category object may be depicted as a container, for example a water bucket. With this analogy, the height of the water level within each bucket could then represent the Student-user Proficiency Level, rising and falling accordingly. Directly correlated to the water level, the Question Difficulty Level may then be represented by graduated markings along the height of the bucket's inner wall, ranging from low difficulty near the bottom to high difficulty near the top. The rise and fall of the water level would therefore relate directly to the markings along the bucket's wall.

As a student-user answers questions from a particular bucket, their Proficiency Level in that topic area is gleaned from the accuracy of each answer, as well as their overall performance history and consistency in the category. In general, a correct answer will increase the user's proficiency measurement in that category, while an incorrect answer will decrease it. A bucket's water level therefore responds to each of the user's attempts to solve a question from that bucket's collection. The issue left unresolved here is the incremental change in height applied to the bucket's water level with each answered question.

On a per question basis, the magnitude of the incremental change in Proficiency Level should vary, and will be determined by the user's recent performance history in the category, specifically the consistency of their demonstrated competence on previous questions from that bucket. Hence, a student-user who has answered most questions in a category correctly will be posed with progressively larger incremental increases in their Proficiency Level for an additional correct answer, and progressively smaller incremental decreases for an additional incorrect answer. The opposite conditions apply to a student-user that has answered most questions in a category incorrectly. A student-user whose performance history sits on the median will face an equally-sized increase or decrease in Proficiency Level for their next answer.

The bucket property that will track and update a user's performance history is the Student-user State rating. This rating identifies a user's recent performance history in a particular bucket, ranging from unsatisfactory to excellent competence. A student-user may qualify for only one State rating at a time. Each State rating determines the magnitude of incremental change that will be applied to a user's Proficiency Level in that bucket upon the next answered question, as discussed in the previous paragraph. The user's performance on the next question will then update the user's recent performance history, and adjust the user's State accordingly before the next question is presented. In terms of the water bucket analogy, a user's State may be illustrated as a range of cups, each of a different size, which can add and remove varying amounts of water to and from the bucket. Before answering each question from a bucket, a student-user is equipped with a particular cup in one hand for adding water and a particular cup in the other hand for removing water, depending on the user's State. The potential incremental change in water level per question is therefore determined based on the user's State. As the user's State rating changes, so do the cup sizes in the user's hands.

Revisiting the discussed functionality of the Proficiency Level in each bucket, it becomes apparent that the full range of the Proficiency scale must be finite, and therefore some other mechanisms must come into play once a user's Proficiency Level in a bucket approaches the extreme boundaries of its defined range. It would be nonsensical to continue adding water to a bucket that is filled to the brim, or removing water from an empty bucket. Instead, approaching these extreme scenarios should trigger a specialized mechanism to either promote or demote the user's focus appropriately to another bucket. This is in fact the case, and the new mechanisms that take over in these situations will lead the discussion into inter-bucket relationships and traversing the curriculum map's links between multiple buckets.

If a user's Proficiency Level in a particular bucket reaches a high enough level, the student-user then qualifies to begin learning about content and attempting questions from the “next” category bucket defined on the curriculum map. Likewise, if a student-user demonstrates insufficient competence in a particular bucket, their Proficiency Level in that bucket drops to a low enough level to begin presenting the student-user with questions from the “previous” category bucket defined on the curriculum map. These upper and lower Proficiency Threshold Levels determine transitional events between buckets and facilitate the development of a user's personalized progression rate and traversal paths through the various conceptual categories on the curriculum map.

The direct relationships between category buckets on the curriculum map are defined based on parallel groupings of similar level concept topics, and prerequisite standards between immediately linked buckets of consecutive parallel groups. These relationships help to determine the general progression paths that may be taken from one bucket to the “next” or “previous” bucket in a curriculum. Beyond the simple path connections, buckets that are immediately linked in the curriculum map also carry a Correlation Index between them, which indicates how directly the buckets are related, and how requisite the “previous” bucket's material is to learning the content of the “next” bucket. These metrics not only determine the transition process between buckets, but also help to dynamically determine the probability of selecting questions from two correlated buckets as a student-user gradually traverses from one to the other (this selection functionality will be addressed shortly under the Question Selection Algorithm section).

Briefly summarizing, there are several levels of mechanisms operating on the curriculum map, both within each category bucket as well as between related category buckets. Within each bucket, a user's performance generates Proficiency measurements, which set Difficulty Level ranges that ultimately determine the difficulty levels of questions selected from that particular category. Between related buckets, directly relevant topics are connected by links on the curriculum map, and characterized by Correlation Indexes that reflect how essential one topic is to learning another.

The present invention is a network (e.g., web-based) computer program product application comprising one or more client and server application modules. The client side application module communicates with the server side application modules, based on student-user input/interaction.

In one exemplary embodiment of the present invention, the client tier comprises a web browser application such as Internet Explorer™ by Microsoft™, and more specifically, a client application based on Flash animated graphics technology and format by Macromedia™.

In one exemplary embodiment of the present invention, the server tier comprises a collection of server processes including a Knowledge Assessment Test module, a Topic Selection module, and a Question Selection module. (collectively also called “Engine”), discussed below.

### Knowledge Assessment Module

The Knowledge Assessment component has the following objectives:
To efficiently identify for each student-user the most appropriate starting topic from a plurality of topics.
To gauge student-user knowledge level across different learning dimensions.

The Knowledge Assessment comprises 3 phases:
Phase 1 consists of several questions (e.g., 5-10) purely numerical questions designed to assess the user's arithmetic foundations.
Phase 2 consists of a dynamic number (depending on user's success) of word problem-oriented numerical questions designed to gauge the user's knowledge of and readiness for the curriculum. The aim of Phase 2 is to quickly and accurately find an appropriate starting topic for each user.
Phase 3 consists of several questions (e.g., 10-20) word problem-oriented questions designed to test the user's ability in all other learning dimensions. If the student-user exhibits particularly poor results in Phase 3, more questions may be posed

### Initial Test Selection

In one embodiment, to enhance the system's intelligence, the system prompts the student-user for date of birth and grade information. After entering the requested date of birth and grade information, the system prompts the student-user with one of several (e.g., six) Phase 1 Tests, based on the following calculation:

Date of Birth is used to compute Age according to the following formula:

SecondsAlive=Number of seconds since midnight on the user's Date of Birth

Age=Floor(SecondsAlive÷31556736)

Grade is an integer between 1 and 12.

The system determines an appropriate Test Number as follows: note that where grade and/or date of birth data is missing, the system uses predetermined logic.

If no data is known (Note: this case should not happen), then Test Number=1

If only date of birth is known, then Test Number=max{1, min{Age−5, 6}}

If only grade is known (Note: this case should not happen), then Test Number=min{Grade, 6}

If both date of birth and grade are known, then Test Number=min{Floor([(2×Grade)+(Age−5)]÷3),6}

### Test Jumps

Depending on the user's progress or level of proficiency, the student-user may jump from one test to another.

### Test Jump Logic

If the student-user answers a certain number of consecutive questions correctly (incorrectly), the student-user will jump up (down) to the root node of the next (previous) test. The requisite number depends on the particular test and is hard-coded into each test. For example, a student-user starting in Test 1 must answer the first four Phase 2 questions correctly in order to jump to Test 2.

### Test Jump Caps

If the student-user jumps up (down) from one Test to another, in one embodiment, the system will prevent the student-user from jumping back down (up) in the future to revisit a Test.

In another embodiment, the student-user may revisit a Test however, the user's starting topic is set to the highest topic answered successfully in the lower level Test. For example, referring to FIG. 2, if the student-user jumps from Test 1 to Test 2, and then subsequently falls back to Test 1, the starting topic is set at the 01N05 test, Phase 2 ends, and Phase 3 of the 01N05 test begins.

### Test Progression

In one embodiment, a student-user proceeds through the Knowledge Assessment module linearly, beginning with Phase 1 and ending with Phase 3. Phase 1 and Phase 2 are linked to specific test levels. Phase 3 is linked to a specific Number topic, namely the Number topic determined in Phase 2 to be the user's starting topic. Two users who start with the same Phase 1 test will take at least part of the same Phase 2 test (though depending on their individual success, one may surpass the other and see more questions), but may take very different Phase 3 tests depending on their performance in Phase 2.

### Knowledge Assessment Question Selection Approach

Each Knowledge Assessment question tests one or both of two skills: word problem-solving skill, and skill in one of the five other learning dimensions. The following variables are used for scoring purposes:

NScore—A running tally of the number of Number-related questions the student-user has answered correctly.
NTotal—A running tally of the number of Number-related questions the student-user has attempted.
PScore—A running tally of the number of Problem Solving-related questions the student-user has answered correctly.
PTotal—A running tally of the number of Problem Solving-related questions the student-user has attempted.
PSkill—Codes whether the question tests proficiency in Word Problems. In general, will be set to 0 for Phase 1 questions, and to 1 for Phase 2 and Phase 3 questions

At the beginning of the Knowledge Assessment, all four of these variables are initialized to zero.

### Assessments Test Phases

The various assessments tests consists of three phases, namely Phase 1, Phase 2 and Phase 3.

### Phase 1

### Overview

Phase 1 is used to assess the user's foundation in numerical problems.

Phase 1 consists of a predetermined number (e.g., 5-10) of hard-coded questions.

The system presents the questions to the student-user in a linear fashion.

### Phase 1 Logic:

1. If the student-user answers a question correctly:
a. NScore is increased by 1.
b. NTotal is increased by 1.
c. The student-user proceeds to the next question referenced in the question's “Correct” field.

2. If the student-user answers a question incorrectly:
a. NScore is not affected.
b. NTotal is increased by 1.
c. The student-user proceeds to the next question referenced in the question's “Incorrect” field.

### Phase 2

### Overview

Phase 2 establishes the user's starting topic. Phase 2 follows a binary tree traversal algorithm. See Figure #. Figure # depicts an exemplary binary tree representing Phase 2 of an Assessment Test 1. The top level is the root node. The bottom level is the placement level, where the user's starting topic is determined. All levels in between are question levels. Nodes that contain pointers to other Tests (indicated by a Test level and Phase number)(See #) are called jump nodes. Each Test Level Phase 2 tree looks look similar to Figure # with varying tree depths (levels).

An exemplary Phase 2 binary tree traversal algorithm is as follows:

Leftward movement corresponds to a correct answer. Rightward movement corresponds to an incorrect answer.

The topmost topic is the root node. This is where the student-user starts after finishing Phase 1. At the root node, the student-user is asked two questions from the specified topic. This is the only node at which two questions are asked. At all other nodes, only one question is asked.

At the root node, the student-user must answer both questions correctly to register a correct answer for that node (and hence move leftward down the tree). Otherwise, the student-user registers and incorrect answer and moves rightward down the tree.

The student-user proceeds in this manner down through each question level of the tree.

The student-user proceeds in this manner until he reaches the placement level of the tree. At this point, he either jumps to Phase 1 of the specified test (if he reaches a jump node) or the system registers a starting topic as indicated in the node.

### Phase 2 Logic:

1. If the student-user answers a question correctly:
a. NScore increases by 1.
b. NTotal increases by 1.
c. If the question's Pskill is set to 1, then
   i. PScore increases by 1.
   ii. PTotal increases by 1.
d. Else if the question's PSkill is set to 0, then
   i. PScore is unaffected.
   ii. PTotal is unaffected.
e. The student-user proceeds to the next question referenced in the question's “Correct” field.

2. If the student-user answers a question incorrectly:
a. NScore is unaffected.
b. NTotal increases by 1.
c. If the question's PSkill is set to 1, then
   i. PScore is unaffected.
   ii. PTotal increases by 1.
d. Else if the question's PSkill is set to 0, then
   i. PScore is unaffected.
   ii. PTotal is unaffected.
e. The student-user proceeds to the next question referenced in the question's “Incorrect” field.

Phase 3

Phase 3 is designed to assess the user's ability in several learning dimensions (e.g., the Measure (M), Data Handling (D), Shapes and Space (S), and Algebra (A) learning dimensions) at a level commensurate with the user's starting Number topic determined in Phase 2. Phase 3 consists of a predetermined number of questions (e.g., 9-27) hard-coded to each starting Number topic. For example, if the user's starting Number topic is determined in Phase 2 to be 01N03, then the student-user is presented with an corresponding 01N03 Phase 3 test.

The Knowledge Assessment lookup tables contain 3 questions from each M, D, S, and A learning dimensions in the PLANETii curriculum.

Each Phase 3 test pulls questions from between 1 and 3 topics in each learning dimension.

### Phase 3 Logic:

1. If the student-user answers a question correctly:
a. If the question's PSkill is set to 1, then
   i. PScore increases by 1.
   ii. PTotal increases by I.
b. Else if the question's PSkill is set to 0, then
   i. PScore is unaffected.
   ii. PTotal is unaffected.
c. The student-user proceeds to the next question referenced in the question's “Correct” field.

2. If the student-user answers a question incorrectly:
a. If the question's PSkill is set to 1, then
   i. PScore is unaffected.
   ii. The PTotal increases by 1.
b. Else if the question's PSkill is set to 0, then
   i. PScore is unaffected.
   ii. The PTotal is unaffected.
c. The student-user proceeds to the next question referenced in the question's “Incorrect” field.

3. If the student-user answered all three questions in any topic incorrectly, the system provides a fallback topic at the end of Phase 3.

Each topic in the M, D, S, and A learning dimensions is coded with a fall-back topic. If the student-user fails a topic, the student-user is given the opportunity to attempt the fallback topic. For example, if a student-user answers all three questions in 03M01 (Length and Distance IV) incorrectly, after the student-user completes Phase 3, the system prompts the student-user with a suggestion to try a fallback topic, e.g., 01M03 (Length and Distance II).

### Data Storage of Knowledge Assessment Information—Database Organization

The content/questions used during the Knowledge Assessment module are stored in a main content-question database. One or more look up tables are associated with the database for indexing and retrieving knowledge assessment information. Exemplary knowledge assessment lookup tables comprise the following fields A-W and optionally fields X-Y:

### Field A: AQID

Field A contains the Knowledge Assessment Question ID code (AQID). This should include the Test level (01-06, different for Phase 3), Phase number (P1-P3), and unique Phase position (see below). Each of the three Phases has a slightly different labeling scheme. For example: 01.P1.05 is the fifth question in Phase 1 of the Level 1 Knowledge Assessment; 03.P2.I1C2 is the third question that a student-user would see in Phase 2 of the Level 3 Knowledge Assessment following an Incorrect and a Correct response, respectively; and 01N03.P3.02 is the second question in the 01N03 Phase 3 Knowledge Assessment.

### Field B: QD

### Field C: Topic Code

### Field D: Index

### Field E: PSL

### Field F: Question Text

Fields B-F are pulled directly from the main content-question database and are used for referencing questions.

### Field G: Answer Choice A Text

### Field H: Answer Choice B Text

### Field I: Answer Choice C Text

### Field J: Answer Choice D Text

### Field K: Answer Choice E Text

Fields G-K contain the five possible Answer Choices (a-e).

Field L: Correct Answer Text.

Fields M-Q contain Incorrect Answer Explanations corresponding to the Answer Choices in fields G-K. The field corresponding to the correct answer is grayed-out.

Field R: Visual Aid Description—The Visual Aid Description is used by Content to create Incorrect Answer Explanations.
Field S: Correct—A pointer to the QID of the next question to ask if the student-user answers the current question correctly.
Field T: Incorrect—A pointer to the QID of the next question to ask if the student-user answers the current question incorrectly.
Field U: NSkill—0 or 1. Codes whether the question involves Number skill. Used for scoring purposes.
Field V: PSkill—0 or 1. Codes whether the question involves Word problem skill. In general, will be set to 0 for Phase 1 questions, and to 1 for Phase and Phase 3 questions. Used for scoring purposes.
Field W: LDPoint—1, 1.2, or 1.8 points for questions in Phase 3, blank for questions in Phase 1 and Phase 2. Depends on PSL of question and is used for evaluation purposes.
Field X: Concepts—Concepts related to the question material. May be used for evaluation purposes in the future.
Field Y: Related Topics—Topics related to the question material. May be used for evaluation purposes in the future.

### Formulas for Test Scoring

During the Knowledge Assessment Test module, the system calculates several scores as follows:

The user's number score in the Numbers learning dimension is calculated via the following formula:

Number Score=min[Floor{[NScore/(NTotal−1)]*5},5]

The user's score in other learning dimensions (e.g., Measure, Data Handling, Shapes and Space and Algebra) is calculated as follows:

First, a score is computed in each topic. In each Measure, Data Handling, Shapes and Space and Algebra learning dimension, there are three questions, one each with a LDPoint value of 1, 1.2, and 1.8. The user's topic score is calculated via the following formula:

Topic Score=Round{Sum of LDPoints of All 3 Questions*(5/4)])

All Topic Scores in a given Learning Dimension are averaged (and floored) to obtain the Learning Dimension Score.

Finally, the user's word problem score is calculated using the following formula:

Word Problem Score=min[Floor{[PScore/(PTotal−1)]*5},5]

### Evaluation of Knowledge Assessment Results

### Overview

At the end of the Knowledge Assessment module, the system prompts the student-user student-user to log out and the parent/instructor to log in to access test results. The system then presents the parent/instructor with a screen relaying the following evaluation information: 1) the name of each of the learning dimensions (currently, five) in which the student-user student-user was tested is listed, along with a 0-5 scale displaying the user's performance and 2) the user's “Word Problem Skill” is assessed on a 0-5 scale.

The parent/instructor can then select a learning dimension or the “Word Problem Skill” to see all relevant questions attempted by the student-user user, along with incorrect answers and suggested explanations.

### Evaluation Standards

Using an exemplary 0-5 scale, a 5 corresponds to full proficiency in a topic. If a student-user scores a 5 in any learning dimension or in word problem solving, the system displays the following message: “[Child Name] has demonstrated full proficiency in [Topic Name].”

A 3-4 corresponds to some ability in that topic. If a student-user scores a 3-4 in any learning dimension or in word problem-solving, the system displays the following message: “[Child Name] has demonstrated some ability in [Topic Name]. PLANETii system will help him/her to achieve full proficiency.”

A 0-2 generally means that the student-user is unfamiliar with the topic and needs to practice the material or master its prerequisites.

Full proficiency in a topic is defined as ability demonstrated repeatedly in all questions in the topic. In the current implementation described herein, a student-user has full proficiency only when he/she answers every question correctly.

Some ability in a topic is defined as ability demonstrated repeatedly in a majority of questions in the topic. In the current implementation, the student-user must answer 2 of 3 questions in any topic correctly.

### Initialization of Water Levels

After completion of the Knowledge Assessment Test module, the water levels of the user's starting topic, any pre-requisites and related topics are initialized (pre-assigned values) according to the following logic:
The water level in the user's starting topic is not initialized.
The water level in any Number topics that are pre-requisites (with a high correlation coefficient (NEW) to the user's starting topic is initialized to 85.
For the other learning dimensions, topics are organized into subcategories.

Consider the following example where one family of topics organized into related sub-topic categories include:
1. 01M01 Length and Distance I
2. 01M03 Length and Distance II
3. 02M01 Length and Distance III
4. 03M01 Length and Distance IV

Suppose a user, after completing the Knowledge Assessment Test module, is tested in topic 03M01 Length and Distance TV: if his/her topic score in 03M01 Length and Distance IV is 5, then a). the water level in 03M01 Length and Distance IV is set to 85 and b) the water level in related topics 01M01 Length and Distance I, 01M03 Length and Distance II, 02M01 02M01 Length and Distance III is set to 85.

If his/her topic score in 03M01 Length and Distance IV is 4, then a) the water level in 03M01 Length and Distance IV is set to S0; and b) the water level in related topics 01M01 Length and Distance I, 01M03 Length and Distance U, 02M01 Length and Distance III is set to 85.

If his/her topic score in 03M01 Length and Distance IV is 3 or below, then a) the water level in 03M01 Length and Distance IV is not initialized; b) the water level in related topic 02M01 Length and Distance III is not initialized; and c) the water level in any related topic in the subcategory at least twice removed from 03M01 Length and Distance IV (in this case, 01M01 Length and Distance 1 and 01M03 Length and Distance II) is initialized to 85.

The water level for a given topic can be assigned during initialization or after a student-user successfully completes a topic. Thus, a pre-assigned water level of 85 during initialization is not the same as an earned water level of 85 by the user. Therefore, a student-user can fall back into a topic with a pre-assigned water level of 85 if need be.

### Topic Selection Algorithm Module

The Topic Selection module is a three step multi-heuristic intelligence algorithm which assesses the eligibility of topics and then ranks them based on their relevance to a given student's past performance. During step one, the Topic Selection module prunes (culls) the list of uncompleted topics to exclude those topics which are not relevant to the student's path and progress. During step two, the Topic Selection module evaluates each eligible topic for relevance using the multi-heuristic ranking system. Each heuristic contributes to an overall ranking of relevance for each eligible topic and then the topics are ordered according to this relevance. During step three, the Topic Selection module assesses the list of recommendations to determine whether to display the recommended most relevant topics.

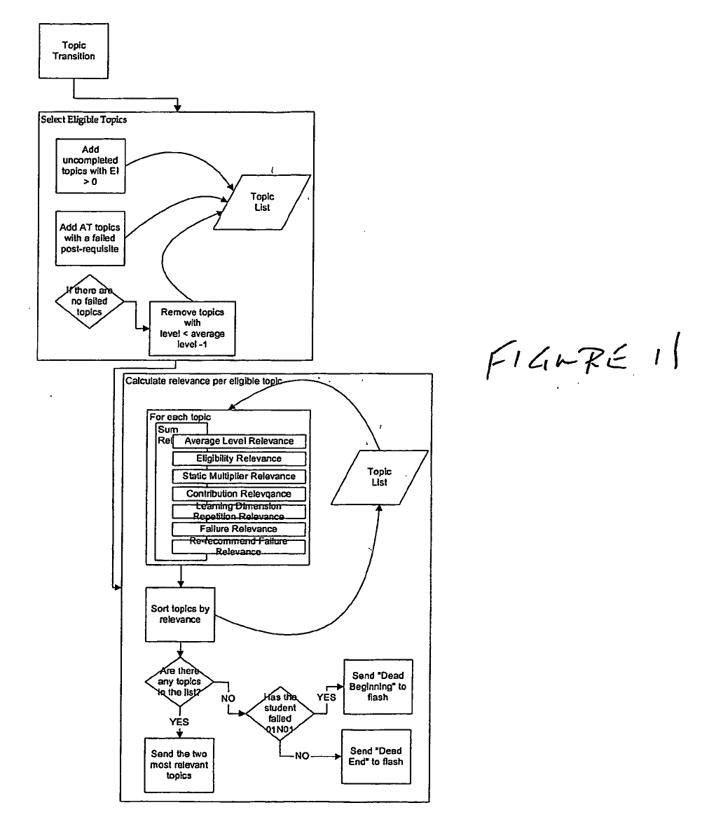

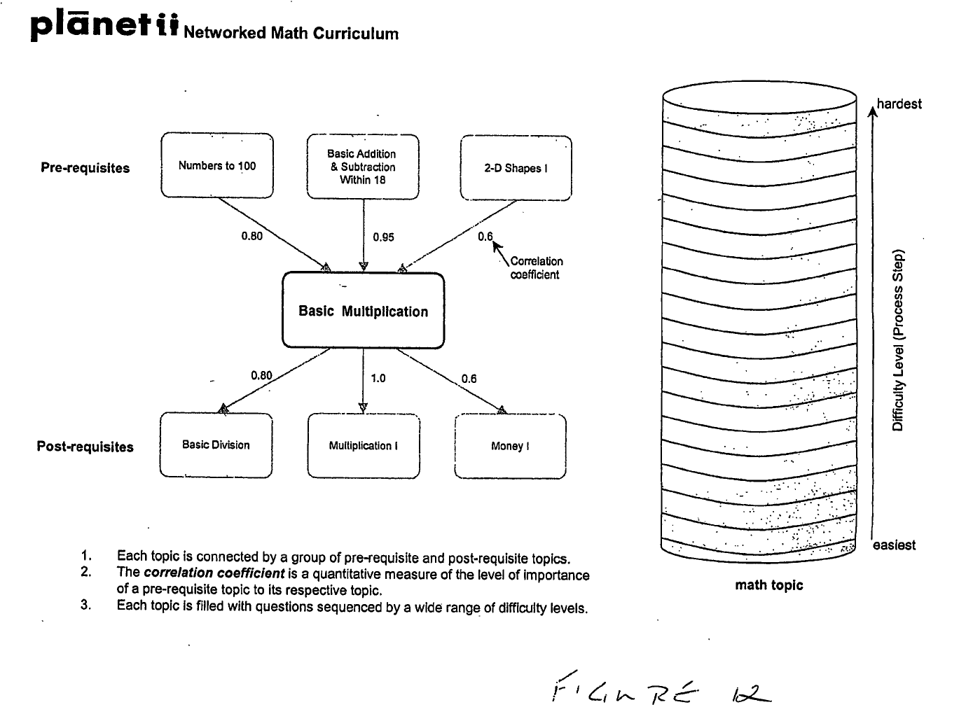

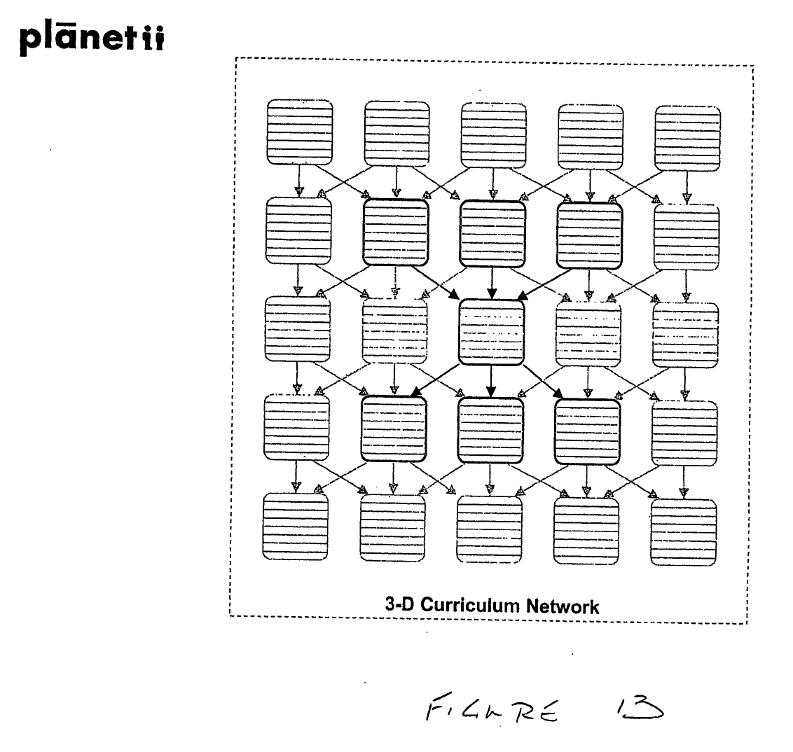

FIG. 11 depicts an exemplary process flow for the Topic Selection Algorithm module.

### Step 1—Culling Eligible Topics

The Topic Selection module employs several culling mechanisms which allow for the exclusion of topics based on the current state of a user's curriculum. The topics that are considered eligible are placed in the list of eligible topics. The first step includes all topics that have an eligibility factor greater than 0, a water level less than 85 and no value from the placement test. This ensures that the student-user will not enter into a topic that they are not ready for or one that they have already completed or tested out of. The last topic a student-user answered questions in is explicitly excluded from the list which prevents the engine from recommending the same topic twice in a row particularly if the student-user fails out of the topic.

After these initial eligibility assertions take place, some additional considerations are made. If there are any topics that are current failed in the user's curriculum, all of the uncompleted pre-requisites of these topics are added to the eligible list. This includes topics that received values from the placement test.

Finally, if there are no failed topics in the student's curriculum and all the topics in the recommendation list that are greater than 1 level away from the student's average level, the list is cleared and no topics are included. This will indicate a “Dead End” situation.

### Step 2—Calculating Relevance

After the list of eligible topics has been compiled, the Topic Selection module calculates a relevance score for each topic. The relevance score is calculated using several independent heuristic functions which evaluate various aspects of a topic's relevance based upon the current state of the user's curriculum. Each heuristic is weighted so that the known range of its values can be combined with the other heuristics to provide an accurate relevance score. The weights are designed specifically for each heuristic so that one particular relevance score can cancel or compliment the values of other heuristics. The interaction between all the heuristics creates a dynamic tension in the overall relevance score which enables the recognition of the most relevant topic for the student-user based on their previous performance.

### Relevance Heuristics Explained

### 1) Average Level Relevance

### Overview:

This heuristic determines a student's average overall level and then rewards topics which are within a one-level window of the average while punishing topics that are further away.

### Formula:

For each level:

LevelAverage=sum(topicWaterLevel*topicLevel)/sum(topicLevel)

Average Level=Sum(LevelAverage)

Topic relevance: (0.5−ABS(topicLevel−Average Level))*5

### Range of Possible Values:

(in current curriculum 1-4): 2.5 to −17.5

### Weighted Range of Possible Values:

(in current curriculum 1-4): 7.5 to −52.5

### 2) Eligibility Relevance

### Overview:

This heuristic assesses the student's readiness for the topic, found by determining how much of each direct pre-requisite a student-user has completed.

### Formula:

If W(PrqN)³85, then set W(PrqN)=85;

wherein:
E(X) be the Eligibility Index of Bucket X,
W(PrqN) be the Water Level of Pre-requisite N of Bucket X Cor(X, PrqN) be the Correlation Index between Bucket X and its Pre-requisite N, where N is the number of pre-requisite buckets for X
t be the constant 100/85

### Range of Possible Values:

(in current curriculum 1-4): 100 to 0

### Weighted Range of Possible Values:

(in current curriculum 1-4): 20 to 0

### 3) Concept Importance (Static Multiplier) Relevance

### Overview:

Concept importance is a predetermined measure of how important a topic is. For example, a topic like “Basic Multiplication” is deemed more important than “The Four Directions.”

### Formula:

### 1—(Topic Multiplier)

### Range of Possible Values:

(in current curriculum 1-4): 1 to 0

### Weighted Range of Possible Values:

(in current curriculum 1-4): 5 to 0

### 4) Contribution Relevance

### Overview:

This heuristic measures the potential benefit completing this topic would provide, by adding its post-requisites' correlations.

### Formula:

SUM(post requisite correlation)

### Range of Possible Values:

(in current curriculum 1-4): ˜6 to 0

### Weighted Range of Possible Values:

(in current curriculum 14): ˜3 to 0

### 5) Learning Dimension Repetition Relevance

### Overview:

This heuristic is meant to ensure a degree of coherence to the student-user while developing a broad base in multiple learning dimensions. The heuristic favors 2 consecutive topics in a particular learning dimension, and then gives precedence to any other learning dimension, so a student-user doesn't overextend his/her knowledge in any one learning dimension.

### Formula:

This heuristic uses a lookup table (see below) of values based on the number of consecutive completed topics in a particular learning dimension.

| | | | | | | | | | |
|---|---|---|---|---|---|---|---|---|---|
| 1) Repetitions | 2) 0 | 3) 1 | 4) 2 | 5) 3 | 6) 4 | 7) 5 | 8) 6 | 9) 7 | 10) 8 |
| 11) Value | 12) 2 | 13) 7.5 | 14) −1 | 15) −5 | 16) −9 | 17) −12 | 18) −17 | 19) −22 | 20) −27 |

### Range of Possible Values:

(in current curriculum 1-4): 7.5 to −27.5

### Weighted Range of Possible Values:

(in current curriculum 1-4): 9.38 to −34.375

### 6) Failure Relevance

### Overview:

This heuristic gives a bonus to topics that are important pre-requisites to previously failed topics. For example, if a student-user fails 01M01 (Length and Distance I), then the pre-requisites of 01M01 will receive a bonus based on their correlation to 01M01. It treats assessment test topics differently than the normal unattempted topics and weights the bonuses it gives to each according to the balance of the correlation between these prerequisites. For example, an assessment test topic's correlation to the failed topic must be higher than the sum of the other unattempted topics or it receives no bonus. All unattempted topics receive a bonus relative to their correlation to the failed topic.

### Formula:

get the kid/bucket data
loop through the failed topics
get this failed topic D
get the topic data for the failed topic ID
if we are a pre-req of the failed topic
sum the unattempted pre-req buckets' correlations
if the AT topic's correlation is higher than the sum of the unattempted pre-reqs
add 5+(5*our correlation−the unattempted sum) to the bonus
otherwise return nothing
otherwise return 10* the pre-req's correlation
return the bonus

### Range of Possible Values:

(in current curriculum 1-4): 10 to 0

### Weighted Range of Possible Values:

(in current curriculum 1-4): 10 to 0

### 7) Additional Failure (Re-Recommend) Relevance

### Overview:

This heuristic promotes failed topics if the student-user has completed most of the pre-requisite knowledge, and demotes topics for which a high percentage of the pre-requisite knowledge has not been satisfied. If the last topic completed was a pre-requisite of this failed topic, this topic receives a flat bonus.

### Formula:

score+=(80−EI)/10;

if(preReq.equals(EngineUtilities.getLastBucket(userId))){score+=3;}

### Range of Possible Values:

(in current curriculum 1-4): 11 to −2

### Weighted Range of Possible Values:

(in current curriculum 1-4): 11 to −2

public double calculateRelevance(String userId, String topicId) {
double score = 0;
// get the kid/bucket data
KidBucketWrapper kbw = new KidBucketWrapper(userId, topicId);
// loop through the failed topics
for(Iterator i = curriculum.getFailedTopics(userId).iterator( );i.hasNext( );) {
// get this failed topic Id
String fTopicId = (String)i.next( );
// get the Topic data for the failed topic id
Topic fTopic = curriculum.getTopic(fTopicId);
// if we are a pre-req of the failed topic
if(fTopic.getPreRequisite(topicId) != null) {
// if we are an AT topic
if(kbw.getAssessmentLevel( ) > 0) {
double preSum = 0;
// sum the unattempted pre-req buckets' corellations
for(Iterator i2 = fTopic.getPreRequisites( );i2.hasNext( );) {
String pre = (String)i2.next( );
Topic preTopic = curriculum.getTopic(pre);
KidBucketWrapper prebw = new KidBucketWrapper(userId, pre);
If(!pre.equals(topicId) && prebw.getAssessmentLevel( ) == 0 &&
prebw.getWaterLevel( ) == 0) {
preSum+=preTopic.getPostRequisite(fTopicId).getCorrelationCoefficient( );
}
}
// if the AT topic's corellation is higher than the sum of the unattempted pre-reqs
if(fTopic.getPreRequisite(topicId).getCorrelationCoefficient( ) > preSum) {
// add 5 + (5 * our correlation − the unattempted sum) to the bonus
score += 5 + (5 * (fTopic.getPreRequisite(topicId).getCorrelationCoefficient( ) − preSum));
}
// otherwise return nothing
else {
return 0;
}
}
// otherwise return 10 * the pre-req's correlation
else {return 10 * fTopic.getPreRequisite(topicId).getCorrelationCoefficient( );
}
}
}
// return the bonus
return score;
}

### Step 3—Assess Recommendations

During the third and final step, the system assesses the list of recommendations to determine whether to display the recommended most relevant topics.

### Eligibility Index

The Eligibility Index represents the level of readiness for the bucket to be chosen. In other words, we ask the question “How ready is the student-user to enter into this bucket?” Hence, the Eligibility Index of a bucket is a measure of the total percentage of pre-requisites being completed by the user. The Eligibility Index is calculated as follow:

### Let E(X) be the Eligibility Index of Bucket X,

### Let W(PrqN) be the Water Level of Pre-requisite N of Bucket X

Let Cor(X, PrqN) be the Correlation Index between Bucket X and its Pre-requisite
N, where N is the number of pre-requisite buckets for X
Let t be the constant 100/85
If W(PrqN)³85, then set W(PrqN)=85;

$$E ( X ) = \frac{{\sum }_{1}^{N} [ t * W ( {Prq}_{N} ) * Cor ( X , {Prq}_{N} ) ]}{{\sum }_{1}^{N} Cor ( X , {Prq}_{N} )}$$

To increase the effectiveness of choosing an appropriate bucket for the user, we introduce a new criteria called Eligibility Index Threshold. If the eligibility index does not reach the Eligibility Index Threshold, then the bucket is considered not ready to be chosen.

### Summary of Relevant Numbers for Implementation

1. Question selection starts at Water Level 25 for any new bucket

### 2. Proficiency Range (Water Level Range) is 0 to 100

### 3. Lower Threshold=10

### 4. Upper Threshold=85

### 5. Force Jump Backward at Water Level 0

### 6. Force Jump Forward at Water Level 100

### 7. Eligibility Index Threshold=80

### Ranking and Special Case Recognition

Once the relevance has been calculated for each eligible topic, the Topic Selection module recommends the two most relevant topics. If there are no topics to recommend (i.e the Culling phase eliminated all possible recommendations), one of two states is identified. The first state is called “Dead Beginning” and occurs when a student-user fails the 01N01 “Numbers to 10” topic. In this case, the student-user is not ready to begin using the Smart Practice training and a message instructing them to contact their parent or supervisor is issued. The second state is called “Dead End” and occurs when a student-user has reached the end of the curriculum or the end of the available content. In this case, the student-user has progressed as far as possible and an appropriate message is issued.

### Question Selection Module

### Overview

Once a topic has been determined for the student-user, the Question Selection Module delivers an appropriately challenging question to the student-user. In doing so, the Question Selection Module constantly monitors the student-user's current water level and locates the question(s) that most closely matches the difficulty level the student-user is prepared to handle. Since water level and difficulty level are virtually synonymous, this means that a student-user currently at (for example) water level 56 should get a question at difficulty level 55 before one at difficulty level 60. If the student-user answers the question correct, his/her water level increases by an appropriate margin; if he/she answers incorrectly, his/her water level will decrease.

Additionally, the Question Selection Module provides that all questions in a topic should be exhausted before delivering a question the student-user has previously answered. If all of the questions in a topic have been answered, the Question Selection Module will search for and deliver any incorrectly answered questions before delivering correctly answered questions. Alternatively and preferably, the system will have an abundance of questions in each topic, therefore, it is not anticipated that student-users will see a question more than once.

### Question Search Process

All questions are each assigned a specific difficulty level from 1-100. Depending on the capabilities of the system processor(s), the system may search all of the questions for the one at the closest difficulty level to a student-user's current water level. Alternatively, during the search process, the system searches within a pre-set range around the student-user's water level. For example, if a student-user's water level is 43, the system will search for all the questions within 5 difficulty levels (from 38 to 48) and will select one at random for the student.

The threshold for that range is a variable that can be set to any number. The smaller the number, the tighter the selection set around the student's water level. The tighter the range, the greater the likelihood of finding the most appropriate question, but the greater the likelihood that the system will have to search multiple times before finding any question.

### General Flow

1. Get the student's current water level
2. Search the database for all questions within (+ or −) 5 difficulty levels of the student's water level. (NOTE: This threshold + or −5 can become tighter to find more appropriate questions, but doing so will increase the demands on the processor.)
3. Serve a question at random from this set.
4. Depending on the students answer, adjust his/her water level according to the water level adjustment table.
5. Repeat the process.

### Governing Guidelines

1. Questions should be chosen from difficulty levels closest the student's current water level. If no questions are found within the stated threshold (in our example, + or −5 difficulty levels), the algorithm will continue to look further and further out (+ or −10, + or −15, and so on).
2. A previously answered question should not be picked again for any particular student-user unless all the possible questions in the topic have been answered.
3. If all questions in a topic have been answered, search for the closest incorrectly answered question.
4. If all questions have been answered correctly, refresh the topic and start again.

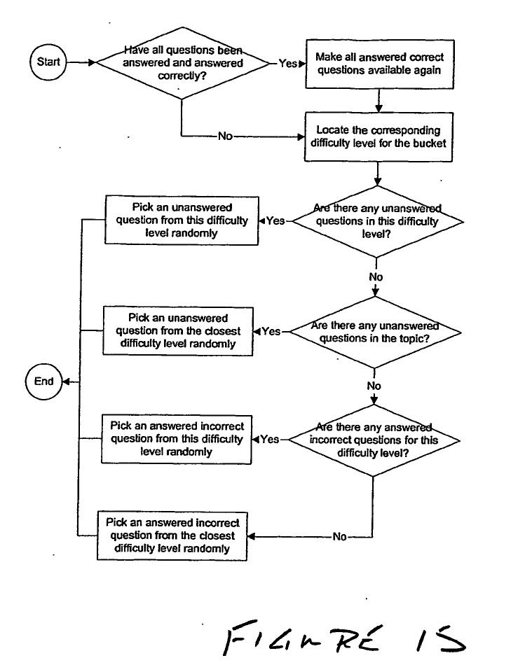

FIG. 15 depicts an exemplary process flow for picking a question from a selected topic-bucket.

### State Level and Water Level Calculations

A State Level indicates the student's consistency in performance for any bucket. When a student-user answers a question correctly, the state level will increase by 1, and similarly, if a student-user answers incorrectly, the state level will decrease by 1. Preferably, the state level has a range from 1 to 6 and is initialized at 3.

A Water Level represents a student's proficiency in a bucket. Preferably, the water level has a range from 0 to 100 and is initialized at 25 when a student-user enters a new bucket.

A Bucket Multiplier is pre-determined for each bucket depending on the importance of the material to be covered in the bucket. The multiplier is applied to the increments/decrements of the water level. If the bucket is a major topic, the multiplier will prolong the time for the student-user to reach Upper Threshold. If the bucket is a minor topic, the multiplier will allow the student-user to complete the topic quicker.

To locate the corresponding water level from the user's current question to the next question, the adjustment of the water level based on the current state of the bucket is as follows:

| State Level that the | Adjustment in water | Adjustment of water |
|---|---|---|
| student-user is | level when a question is | level when a question is |
| currently in: | answered correctly: | answered incorrectly: |
| 1 | +0m | −5m |
| 2 | +1m | −3m |
| 3 | +1m | −2m |
| 4 | +2m | −1m |
| 5 | +3m | −1m |
| 6 | +5m | −0m |

m = Bucket Multiplier

### Data Transfer

The communications are handled securely, using a 128-bit SSL Certificate signed with a 1024-bit key. This is currently the highest level of security supported by the most popular browsers in-use today.

The data that is exchanged between the client and server has 2 paths: 1) from the server to the client, and 2) from the client to the server. The data sent from the client to the server is sent as a POST method. There are two main ways to send information from a browser to a web server, GET and POST. POST is the more secure method. The data sent from the server to the client is sent via the Extensible Markup Language (XML) format, which is widely accepted as the standard for exchanging data. This format was chosen because of its flexibility, and allows the system to re-use, change, or extend the data being used more quickly and efficiently.

### CONCLUSION

Having now described one or more exemplary embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

Moreover, the techniques may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, NVRAM, ROM, hard disk, magnetic diskette or carrier wave) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Finally, an embodiment of the present invention having potential commercial success is integrated in the Planetii™ Math System™, an online math education software product, available at <http://www.planetii.com/home/>.

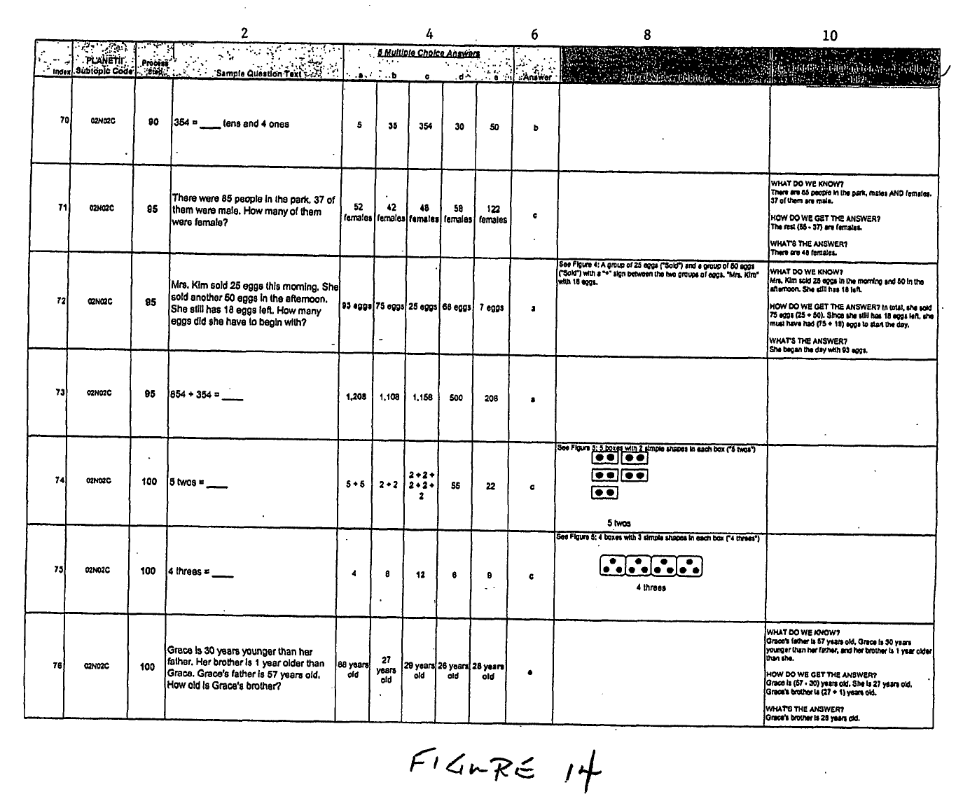

FIG. 14 depicts an exemplary user interface depicting the various elements for display. As shown, the question text data is presented as Display Area 2, the potential answer choice(s) data is presented as Display Area 4, the correct answer data is presented as Display Area 6, the Visual Aid data is presented as Display Area 8 and the Descriptive Solution data is presented as Display Area 10.

What is claimed is:

1. An adaptive learning system for presenting an appropriate topic and question to a user, said system comprising:
a processor configured to:
generate and store in a database a set of hierarchical topics having a plurality of questions associated with each one of said topics; each of said plurality of questions within a topic having an assigned difficulty level value;
determine an adjustable state level value for a user based on said user's topic performance consistency; said state level initialized to and having a range of predetermined value;
determine an adjustable water level value for said user based on said user's proficiency in at least a subset of said hierarchical topics; said water level initialized to and having a range of predetermined value;
determine a relevant topic for said user from said set of hierarchical topics by performing the following:
cull said set of hierarchical topics to determine one or more eligible academic topics; and
evaluate for relevance said one or more eligible academic topics using heuristic relevance ranking to determine said relevant academic topic;
determine an appropriate question for said user from said plurality of relevant academic topic questions by performing the following:
determine said user's water level,
search said database for one or more questions within a threshold range from said user's water level,
randomly select a relevant question from this one or more questions
depending on the user's answer to said selected question, adjust said user's water level according to a predetermined adjustment table.

2. The system as in claim 1 wherein said processor is further configured to evaluate for relevance said one or more eligible academic topics using at least one of a Average Level Relavance heuristic, Eligibility Relevance heuristic, Static Multiplier Relevance heuristic, Contribution Relevance heuristic, Learning Dimension Repetition Relevance heuristic, Failure Relevance heuristic and Re-recommend Failure Relevance heuristic.

3. The system as in claim 1 wherein said processor further defines a multiplier value m, said state level value is initialized to 3 and ranging from 1 to 6, said, water level value is initialized to 25 and ranging from 0 to 100 and said predetermined adjustment table comprises:

| State Level | Adjustment in water level | Adjustment of water level |
|---|---|---|
| that said user | when a question is | when a question is |
| is currently in: | answered correctly: | answered incorrectly: |
| 1 | +0m | −5m |
| 2 | +1m | −3m |
| 3 | +1m | −2m |
| 4 | +2m | −1m |
| 5 | +3m | −1m |
| 6 | +5m | −0m |

m = Multiplier

4. The system as in claim 1 wherein said difficulty level value ranges from 1 to 100;

5. The system as in claim 1 wherein said threshold range is from ±0 to ±5.

6. The system as in claim 1 wherein said threshold range is greater than ±5.
